(19) United States
(12) Patent Application Publication
(10) Pub. No.: US 2019/0351270 A1
(43) Pub. Date: Nov. 21, 2019

(54) Fire Extinguishing Equipment

(71) Applicant: SENJU SPRINKLER CO., LTD., Tokyo (JP)

(72) Inventors: Yukihiro Kon, Tokyo (JP); Shou Chiba, Tokyo (JP)

(73) Assignee: SENJU SPRINKLER CO., LTD., Tokyo (JP)

(21) Appl. No.: 16/413,182

(22) Filed: May 15, 2019

(30) Foreign Application Priority Data
May 21, 2018 (JP) 2018-096747
May 21, 2018 (JP) 2018-096748
May 21, 2018 (JP) 2018-096749

(51) Int. Cl. A62C 35/68; A62C 35/64

(52) U.S. Cl. CPC A62C 35/68; A62C 35/64

(57) ABSTRACT

A FIRE EXTINGUISHING EQUIPMENT includes a pump that feeds water to piping, a water flow detection device connected to the pump, a sprinkler head connected to secondary piping of the water flow detection device, and a pump start switch installed in primary piping between the pump and the water flow detection device. The primary piping is divided in correspondence with plural fire protection areas. The water flow detection device is installed in each branch of the primary piping. A relief valve provided in bypass piping that connects between the primary piping and the secondary piping not via the water flow detection device is opened when the difference between the primary-side and secondary-side pressures is equal to or more than a predetermined value. The cross-sectional area of a minimum flow passage diameter portion of the relief valve is smaller than the cross-sectional area of a nozzle outlet of the sprinkler head.

### BACKGROUND OF THE INVENTION

### 1. Field of the Invention

The present invention relates to a FIRE EXTINGUISHING EQUIPMENT such as a sprinkler equipment and a foam FIRE EXTINGUISHING EQUIPMENT.

### 2. Description of the Related Art

A FIRE EXTINGUISHING EQUIPMENT such as a sprinkler equipment and a foam FIRE EXTINGUISHING EQUIPMENT includes a water flow detection device installed on piping that extends from a water source to a sprinkler head or a foam head. The water flow detection device has a check valve structure, and allows passage of water in one direction from the water source to the sprinkler head or the foam head only. Water charged inside secondary piping, in which the sprinkler head is installed, is expanded and contracted because of seasonal temperature differences. In summer, in particular, the water in the secondary piping is expanded and pressurized, which may break the sprinkler head. In winter, meanwhile, the water in the secondary piping is compressed and pressurized when the water in the piping is frozen and expanded in volume, which may cause a damage similar to that described above.

Japanese Unexamined Patent Application Publication No. 8-131574 discloses an example of how to address an issue with a FIRE EXTINGUISHING EQUIPMENT according to the related art. In Japanese Unexamined Patent Application Publication No. 8-131574, a water flow detection device includes a bypass flow path that connects between the primary side and the secondary side of the water flow detection device. The bypass flow path is provided with a differential pressure valve that functions as a relief mechanism. The differential pressure valve opens when the pressure on the secondary side of the water flow detection device becomes higher than the pressure on the primary side thereof by a predetermined value or more. When the differential pressure valve opens and water flows from secondary piping to primary piping, the secondary-side pressure is reduced. This prevents breakage of the sprinkler head.

FIG. 9 illustrates an overview of the FIRE EXTINGUISHING EQUIPMENT according to the related art discussed above. In FIG. 9, the differential pressure valve which functions as a relief mechanism is not illustrated. In the FIRE EXTINGUISHING EQUIPMENT, in the case where a fire occurs in a predetermined fire protection area of a building, a sprinkler head Sa installed in the fire protection area is actuated to discharge water in secondary piping 2a. Consequently, the pressure in the secondary piping 2a becomes lower than the pressure in primary piping 1, which causes a water flow detection device 3a to open the valve body thereof and output an actuation signal. When the water flow detection device 3a is opened, water in the primary piping 1 is supplied to the secondary piping 2a, which lowers the pressure in the primary piping 1.

The primary piping 1 is also connected to water flow detection devices 3b and 3c corresponding to other fire protection areas. Therefore, a pressure difference is caused between the primary piping 1 and secondary piping 2b and 2c for differential pressure valves (relief mechanisms) in bypass flow paths provided for the water flow detection devices 3b and 3c for the fire protection areas in which a fire is not caused. When the pressure difference becomes equal to or more than a predetermined value, the differential pressure valves in the bypass flow paths for the water flow detection devices 3b and 3c are opened, and water in the secondary piping 2b and 2c for the fire protection areas in which a fire is not caused flows to the primary piping 1. Then, the pressure in the primary piping 1 is lowered slowly, and it may take time before the pressure reaches a prescribed pressure at which a pump start switch 5 installed on the primary piping 1 is actuated. Consequently, although the sprinkler head Sa is actuated in the fire protection area in which a fire is caused, sufficient water may not be fed with actuation of the pump start switch 5 delayed, which may disturb initial fire fighting.

### SUMMARY OF THE INVENTION

The present invention has been made in view of the related art described above as the background. It is an object of the present invention to provide a FIRE EXTINGUISHING EQUIPMENT that includes a relief mechanism from secondary piping to primary piping and that allows a pump to be started without delay at the time of a fire.

In order to achieve the foregoing object, the present invention provides the following FIRE EXTINGUISHING EQUIPMENT.

That is, a FIRE EXTINGUISHING EQUIPMENT includes a pump that feeds water in a water source, primary piping connected to the pump, a water flow detection device connected to the primary piping, secondary piping connected to the water flow detection device, and a sprinkler head connected to the secondary piping; the primary piping includes a plurality of branched pipes that extend as branched in correspondence with a plurality of fire protection areas of a building, the water flow detection device being connected to each of the branched pipes; the FIRE EXTINGUISHING EQUIPMENT further includes first bypass piping that passes outside the water flow detection device to connect between the primary piping and the secondary piping, and a relief valve provided in a conduit of the first bypass piping; the relief valve is opened to supply water in the secondary piping to the primary piping when a difference of a secondary-side pressure in the secondary piping with respect to a primary-side pressure in the primary piping becomes more than a first pressure difference; and a cross-sectional area of a minimum flow passage diameter portion of the relief valve is smaller than a cross-sectional area of a nozzle outlet of the sprinkler head.

With the present invention, the cross-sectional area of the minimum flow passage diameter portion of the relief valve is smaller than the cross-sectional area of the nozzle outlet of the sprinkler head. Therefore, when a fire occurs, the amount of water supplied from the secondary piping to the primary piping through the relief valve in a non-fire system is less than the flow rate of water discharged from the sprinkler head in the fire system. Thus, the amount of water supplied from the relief valve in the non-fire system, which may cause a slow reduction in the pressure in the primary piping, can be suppressed. Consequently, the pump start switch is actuated with the pressure in the primary piping lowered without delay. Then, sufficient water is fed from the pump to the sprinkler head for the fire protection area in which a fire is caused. The “minimum flow passage diameter portion” discussed above indicates a portion at which the cross-sectional area of a portion that enables passage of a fluid on a virtual plane that perpendicularly intersects the center axis of the relief valve is minimum.

### BRIEF DESCRIPTION OF THE DRAWINGS

FIG. 1 illustrates a piping system of a FIRE EXTINGUISHING EQUIPMENT according to a first embodiment;

FIG. 2 is a front view of a water flow detection device illustrated in FIG. 1;

FIG. 3 is a plan view of the water flow detection device in FIG. 2;

FIG. 4 is a front view of the water flow detection device in FIG. 2 with a cover removed;

FIG. 5 is a sectional view of a relief valve illustrated in FIG. 2;

FIGS. 6A and 6B illustrate a sprinkler head illustrated in FIG. 1, in which FIG. 6A is a sectional view of the sprinkler head and FIG. 6B is a sectional view of a nozzle outlet;

FIG. 7 illustrates a piping system of a FIRE EXTINGUISHING EQUIPMENT according to a second embodiment;

FIG. 8 illustrates a piping system of a FIRE EXTINGUISHING EQUIPMENT according to a third embodiment; and

FIG. 9 illustrates a piping system of a sprinkler equipment (FIRE EXTINGUISHING EQUIPMENT) according to the related art.

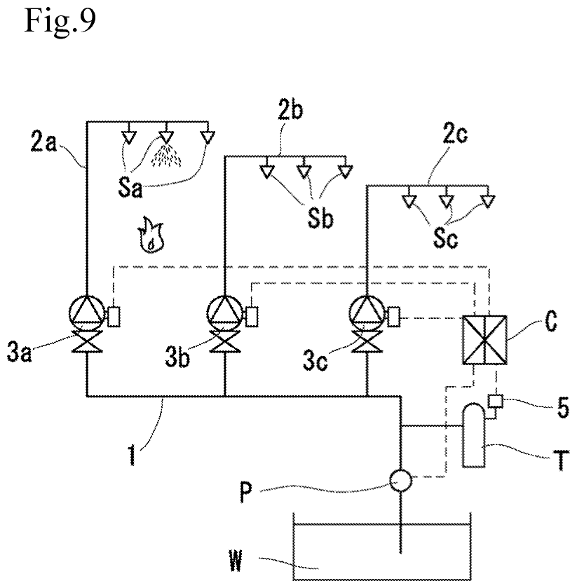

### DESCRIPTION OF THE PREFERRED EMBODIMENTS

A FIRE EXTINGUISHING EQUIPMENT according to an embodiment of the present invention will be described below with reference to the drawings.

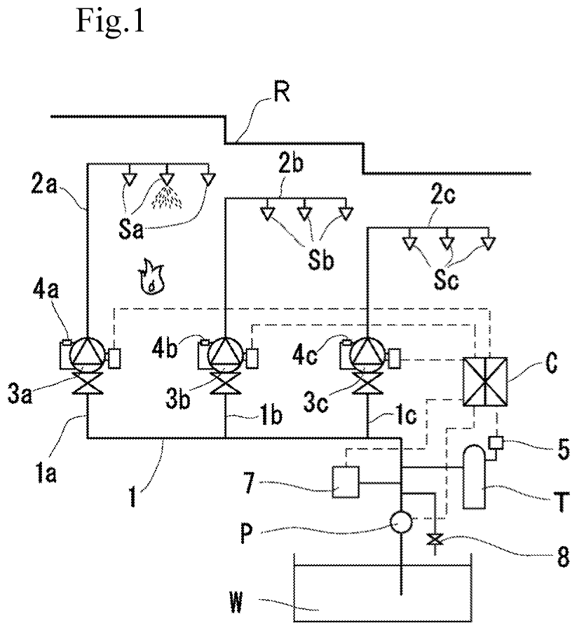

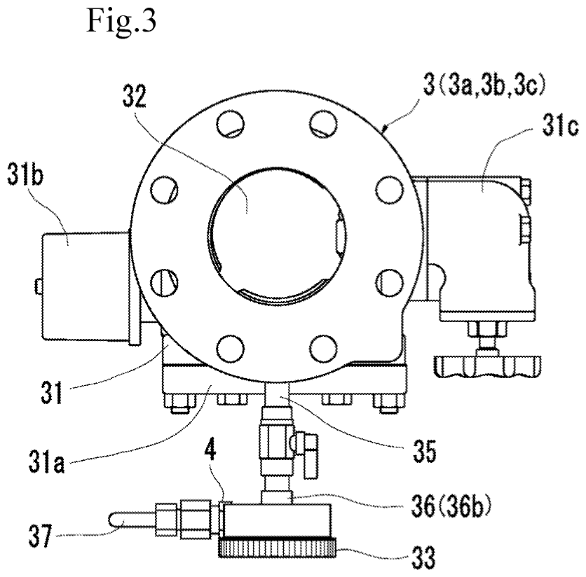

### First Embodiment [FIGS. 1 to 6]

FIG. 1 illustrates a sprinkler equipment which is a “FIRE EXTINGUISHING EQUIPMENT” according to an embodiment of the present invention. The sprinkler equipment includes a water source W, a pump P, primary piping 1 (1a, 1b, 1c), secondary piping 2 (2a, 2b, 2c), a water flow detection device 3 (3a, 3b, 3c), and a sprinkler head S (Sa, Sb, Sc).

The water source W is a water storage tank that stores water to be used to extinguish a fire. The water storage tank is installed under a building, for example. The pump P is installed near the water source W. The pump P pumps water in the water source W to the primary piping 1.

The primary piping 1 is provided with water flow detection devices 3a, 3b, and 3c. The water flow detection devices 3a, 3b, and 3c are installed in correspondence with a plurality of fire protection areas provided in the building. Therefore, the primary piping 1 includes branched pipes 1a, 1b, and 1c branched in parallel at the middle thereof. The branched pipes 1a, 1b, and 1c are connected with the corresponding water flow detection devices 3a, 3b, and 3c, respectively.

A pressure tank T is provided between the water flow detection devices 3 and the pump P. The pressure tank T is provided with a pump start switch 5. The pump start switch 5 is actuated to start the pump P when the pressure (primary-side pressure) in the primary piping 1 becomes equal to or less than a predetermined set pressure value. In the present embodiment, the set pressure value at which the pump start switch 5 is actuated is determined as 0.6 MPa.

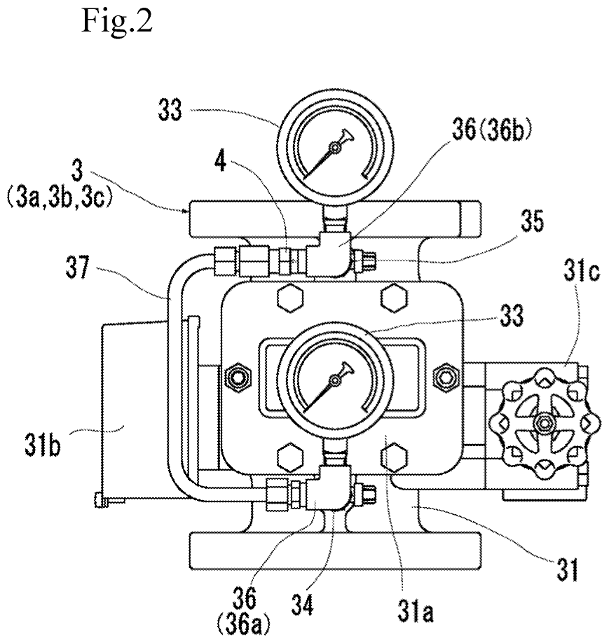

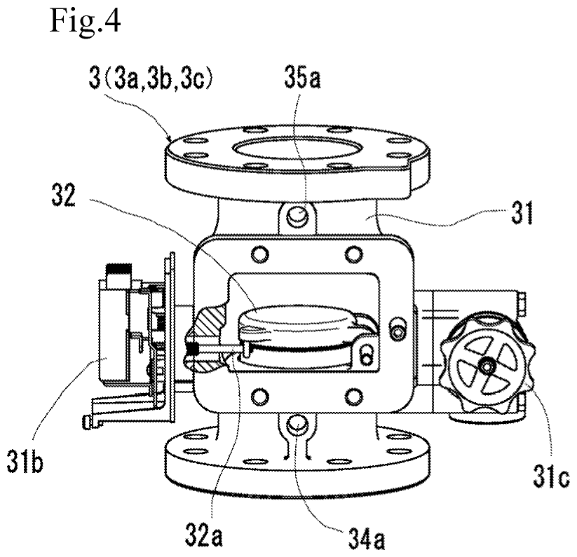

As illustrated in FIGS. 2 to 4, the water flow detection device 3 (3a, 3b, 3c) includes a valve element 32 of a swing chuck structure provided inside a tubular body 31. The valve element 32 has a disc shape. The valve element 32 is closed at normal times. The valve element 32 allows passage of water from the primary piping 1 to the secondary piping 2 only. The water flow detection device 3 is a water flow detection device of an actuated valve type that outputs a signal upon detecting displacement due to opening of the valve element 32. Specifically, when the valve element 32 is turned to open a water passage inside the water flow detection device 3, a stem 32a (FIG. 4) connected to a water flow detection mechanism 31b provided outside the body 31 is displaced along with the turn of the valve element 32. When the displacement of the stem 32a is detected by a limit switch (not illustrated) provided inside the water flow detection mechanism 31b, the limit switch outputs a signal. An example of the thus structured water flow detection device is described in Japanese Unexamined Patent Application Publication No. 2010-5429 and Japanese Unexamined Patent Application Publication No. 2016-135451. Besides the thus structured water flow detection device, a water flow detection device described in Japanese Unexamined Patent Application Publication No. 2001-190706, in which a hole formed in a valve seat and a pressure switch provided outside a body are connected so as to enable passage of water, may also be used. The structure of the water flow detection device 3 is not described in detail herein.

An opening portion covered by a cover 31a is provided on the front side of the water flow detection device 3. The water flow detection mechanism 31b is disposed on one side surface of the water flow detection device 3, and a water discharge valve 31c is disposed on the other side surface thereof.

First piping 34 and second piping 35 are installed on the front side of the body 31. The first piping 34 is connected to a first hole 34a (FIG. 4) provided at a position of the body 31 on the side of the primary piping 1 with respect to the valve element 32. The second piping 35 is connected to a second hole 35a (FIG. 4) provided at a position of the body 31 on the side of the secondary piping 2 with respect to the valve element 32. The first piping 34 and the second piping 35 are connected to respective three-way joints 36 (a three-way joint 36a on the primary side and a three-way joint 36b on the secondary side). A pressure gauge 33 is installed at the upper connection port, illustrated in FIG. 2, of each three-way joint 36. Third piping 37 bent in a C-shape is connected to the left connection port, illustrated in FIG. 2, of each three-way joint 36. The first piping 34, the third piping 37, and the second piping 35 constitute “first bypass piping” according to the present invention that connects between the primary piping 1 and the secondary piping 2 by bypassing a water passage inside the water flow detection device 3, which is opened and closed by the valve element 32, by passing outside the water flow detection device 3.

The first bypass piping can be installed on the body 31 of the water flow detection device 3 as described above. Alternatively, the first bypass piping can be constituted by directly connecting the first piping 34 to the primary piping 1 and directly connecting the second piping 35 to the secondary piping 2.

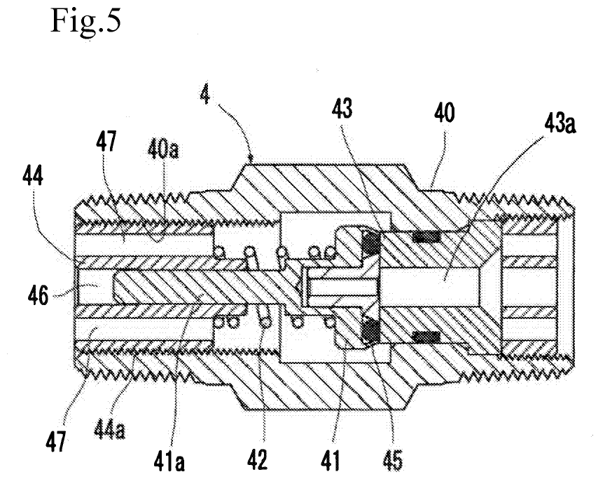

A relief valve 4 is provided between an end portion of the third piping 37 on the secondary side and the three-way joint 36b on the secondary side. The relief valve 4 also constitutes a part of the “first bypass piping”, and enables passage of water from the secondary piping 2 to the primary piping 1. As illustrated in FIG. 5, the relief valve 4 has a tubular body 40. A valve element 41 is provided inside the body 40. The valve element 41 is urged toward a valve seat 43 by a spring 42. Consequently, the valve element 41 normally closes an internal flow path of the body 40.

An end (end portion on the secondary side), on the side on which the valve seat 43 is installed, of the body 40 of the relief valve 4 is connected to the second piping 35 (secondary piping 2). On the other hand, an end (end portion on the primary side), on the side on which a tubular holder 44 is installed, of the body 40 is connected to the third piping 37. The body 40 is disposed at a position (at a position along the horizontal direction) at which the body 40 intersects the flow direction of the water flow detection device 3 (direction from the lower side toward the upper side in FIGS. 2 and 4). With such a configuration, the body 40 can be installed in an attitude (in an attitude along the horizontal direction) in which the body 40 is horizontally long as illustrated in FIG. 2. In the water flow detection device 3 of the actuated valve type, in particular, the dimension between flange surfaces of the body 31 (height of the body 31) is generally small. Therefore, the relief valve 4 can be installed in a conduit of the “first bypass piping”, which is installed on the body 31, by installing the relief valve 4 in an attitude along the horizontal direction.

The spring 42 is installed between the valve element 41 and the holder 44. When a pressure (secondary-side pressure) in the second piping 35 (secondary piping 2) becomes higher than a pressure (primary-side pressure) in the first piping 34 (primary piping 1) by a pressure difference (first pressure difference) of more than 0.3 to 0.4 MPa, the spring 42 is contracted by the secondary-side pressure in the secondary piping 2, which is applied to the valve element 41. When the spring 42 is contracted by being pressed by the valve element 41, the valve element 41 which receives the secondary-side pressure is moved leftward in FIG. 5 away from the valve seat 43. When the valve element 41 is moved away from the valve seat 43, the internal flow path of the body 40 is opened, and water in the secondary piping 2 flows into the primary piping 1.

A force that the spring 42 applies to the valve element 41 can be adjusted by changing the position of the holder 44 inside the body 40. The valve element 41 is opened when the pressure difference of the secondary-side pressure with respect to the primary-side pressure becomes more than a predetermined set value (first pressure difference) as discussed earlier.

In a first state in which the pressure difference is caused, the fluid pressure on the inflow side (secondary piping 2) is raised when the valve element 41 is closed to cause a difference from the fluid pressure on the outflow side (primary piping 1). In a second state in which the pressure difference is caused, the fluid pressure on the outflow side (primary piping 1) is lowered to cause a difference from the fluid pressure on the inflow side (secondary piping 2). In either case, the valve element 41 is not opened by a slight pressure difference, but the valve element 41 is opened after a pressure difference that is more than a predetermined set value is caused. To that end, the spring 42 presses and holds the valve element 41 against the valve seat 43.

Specifically, when the maximum use pressure of the water flow detection device 3 is 1.4 MPa and the pressure of water charged in the secondary piping 2 is 1 MPa, the valve element 41 is set so as to be opened before the pressure difference reaches 0.4 MPa, in order that the valve element 41 is opened before the maximum use pressure of the water flow detection device 3 is exceeded. Preferably, the set value for the pressure difference is set in the range of 0.15 MPa to 0.4 MPa. In the present embodiment, the valve element 41 is set so as to be opened when the pressure difference is in the range of 0.3 MPa to 0.4 MPa.

The valve seat 43 has a cylindrical shape. A fluorine resin is used as the material of the valve seat 43. The material of an O-ring 45, which is provided on the valve element 41 which contacts the valve seat 43, is fluorocarbon rubber. This prevents adhesion of the valve element 41 and the valve seat 43 after being in a closed state over a long period. The material of the valve seat 43 is not limited to the fluorine resin, and the valve seat 43 which is made of metal and the surface of which is coated with a fluorine resin may also be used. Only a surface of the valve seat 43 for abutment with the valve element 41 may be coated with a fluorine resin.

A hole 43a is formed inside the valve seat 43. The hole 43a corresponds to the “minimum flow passage diameter portion”, and the cross-sectional area of the hole 43a corresponds to the “cross-sectional area of the minimum flow passage diameter portion”. The “minimum flow passage diameter portion” is a portion at which the cross-sectional area of a portion that enables passage of a fluid on a virtual plane that perpendicularly intersects the center axis of the body 40 of the relief valve 4 is minimum.

The holder 44 has male threads 44a on the outer peripheral surface thereof. The male threads 44a are engaged with female threads 40a provided in the inner peripheral surface of the body 40. This enables the position of the holder 44 to be changed inside the body 40, which allows adjustment of the force of the spring 42 to press the valve element 41. The holder 44 has a center hole 46 and a plurality of flow passage holes 47 formed around the center hole 46. In the present embodiment, four flow passage holes 47 are provided. The center hole 46 and the flow passage holes 47 are each formed to have an equal diameter from one end side to the other end side.

A valve shaft 41a that extends from the valve element 41 toward the holder 44 is inserted through the center hole 46. The center hole 46 has a function of guiding the valve shaft 41a when the valve element 41 opens and closes the hole 43a of the valve seat 43. When the valve element 41 is opened, water charged inside the secondary piping 2 passes through the plurality of flow passage holes 47 to flow into the primary piping 1.

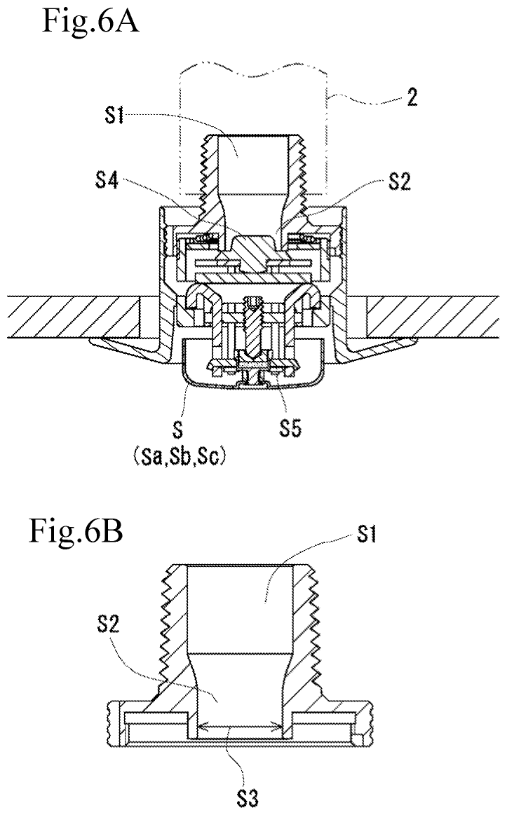

The sprinkler head S (Sa, Sb, Sc) is installed in the secondary piping 2, and automatically actuated upon detecting heat from a fire. As illustrated in FIGS. 6A and 6B, the sprinkler head S includes a nozzle S1 provided inside and connected to the secondary piping 2. An outlet S2 of the nozzle S1 has an equal inside diameter along the axial direction of the nozzle. A diameter S3 of the nozzle S1 on the side of the outlet S2 is set such that the amount of water to be discharged is 80 L/min. The outlet S2 of the nozzle S1 is closed by a valve S4 at normal times. The valve S4 is supported by a heat decomposable portion S5. The heat decomposable portion S5 is decomposed by heat from a fire. Examples of the heat decomposable portion S5 are described in Japanese Unexamined Patent Application Publication No. Hei 7-284545 and Japanese Unexamined Patent Application Publication No. 2015-37678.

The cross-sectional area of the minimum flow passage diameter portion of the hole 43a of the relief valve 4 is smaller than the cross-sectional area (opening area) of the outlet S2 of the nozzle S1 of the sprinkler head S. Specifically, the ratio of the cross-sectional area of the minimum flow passage diameter portion of the relief valve 4 and the cross-sectional area of the outlet S2 of the nozzle S1 of the sprinkler head S is equal to or less than 1:0.3. When the value of the ratio of the cross-sectional area of the minimum flow passage diameter portion is too small, the inside of the relief valve 4 tends to be clogged with dust. Thus, the ratio is preferably in the range of 1:0.2 to 0.03.

In the relief valve 4, the cross-sectional area of the hole 43a inside the valve seat 43 is determined as the “cross-sectional area of the minimum flow passage diameter portion”. In the case where the sum total of the cross-sectional areas of all the (four) flow passage holes 47 of the holder 44 is smaller than the cross-sectional area of the hole 43a, however, the sum total of the cross-sectional areas of all the flow passage holes 47 is determined as the “cross-sectional area of the minimum flow passage diameter portion”. In this manner, the “minimum flow passage diameter portion” refers to an internal passage of the relief valve 4 with the minimum water passage amount in the direction of water passage through the relief valve 4.

Next, operation of the FIRE EXTINGUISHING EQUIPMENT at the time of a fire will be described.

In the FIRE EXTINGUISHING EQUIPMENT illustrated in FIG. 1, the pressure (secondary-side pressure) in the secondary piping 2 is set to be higher than the pressure (primary-side pressure) in the primary piping 1 at normal times (in the absence of a fire). For example, when the pressure in the secondary piping 2 is 1 MPa, the pressure in the primary piping 1 is lower at 0.8 MPa. The actuation pressure of the pump start switch 5 is 0.6 MPa as discussed earlier.

When a fire occurs in a fire protection area of the water flow detection device 3a, the sprinkler head Sa which is connected to the secondary piping 2a of the water flow detection device 3a is actuated. When the sprinkler head Sa is actuated, the outlet S2 of the nozzle S1 which has been closed by the valve is opened to sprinkle water in the secondary piping 2a in rooms of the building. Consequently, the pressure in the secondary piping 2a, which is “fire system piping”, is lowered.

When the secondary piping 2a is depressurized, the valve element 32 of the water flow detection device 3a is opened to supply water from the primary piping 1 to the secondary piping 2. In addition, the water flow detection device 3a outputs an actuation signal along with operation to open the valve element 32. When the pressure in the primary piping 1 is gradually reduced to become lower than 0.7 MPa, the valve elements 41 of the relief valves 4b and 4c, which are connected to the secondary piping 2b and 2c which serves as “non-fire system piping” corresponding to fire protection areas in which a fire is not caused, are opened.

At this time, the amount of water supplied from the secondary piping 2b and 2c to the primary piping 1 via the relief valves 4b and 4c is less than the amount of water discharged from the sprinkler head Sa which has been actuated. Therefore, the primary piping 1 is further depressurized. When the pressure in the primary piping 1 reaches 0.6 MPa, the pump start switch 5 is actuated to start the pump P. Water in the water source W is continuously fed from the pump P, and a sufficient amount of water is sprinkled from the sprinkler head Sa, which has been actuated, to extinguish the fire.

Subsequently, components of the FIRE EXTINGUISHING EQUIPMENT according to the first embodiment that have not been described yet will be described.

An auxiliary pressurization pump 7 is provided on the primary piping 1 between the pump P and the water flow detection device 3. The auxiliary pressurization pump 7 has a small discharge amount and requires a small amount of electric power to operate, compared to the pump P described earlier. In winter, for example, the pressure in the secondary piping 2 may be reduced and the valve element 32 of the water flow detection device 3 may be opened slightly, which may cause water to flow from the primary piping 1 to the secondary piping 2. The auxiliary pressurization pump 7 is used on such occasions when the primary piping 1 is depressurized in the absence of a fire in this manner. In the case where the pressure in the primary piping 1 at the time of start of the pump P is set to 0.6 MPa and the pressure in the primary piping 1 at which the auxiliary pressurization pump 7 is started is set to 0.7 MPa, the auxiliary pressurization pump 7 can be started to feed water before the pump P is started, which allows recovery of the pressure in the primary piping 1 which has been reduced. The amount of water that flows when the relief valve 4 is opened is smaller than the discharge amount of the auxiliary pressurization pump 7.

The auxiliary pressurization pump 7 is set such that the pressure difference (first pressure difference) at the time when the relief valve 4 is opened is larger than the pressure difference (second pressure difference) between the secondary-side pressure in the secondary piping 2 at normal times and the primary-side pressure in the primary piping 1 at the time when the auxiliary pressurization pump 7 is actuated.

More particularly, in the case where the pressure in the secondary piping 2 is 1 MPa and the pressure to start the auxiliary pressurization pump 7 is 0.7 MPa, the pressure difference (second pressure difference) is 0.3 MPa, which is smaller than the pressure difference (first pressure difference, which is 0.3 to 0.4 MPa) at which the relief valve 4 is opened discussed earlier. Therefore, in the case where water in the primary piping 1 leaks and the primary piping 1 is depressurized in the absence of a fire, the auxiliary pressurization pump 7 is started to supply water from the water source W to the primary piping 1. The auxiliary pressurization pump 7 stops operation when the pressure in the primary piping 1 reaches a predetermined pressure. In this manner, the relief valve 4 is not opened even if water leaks from the primary piping 1 in the absence of a fire.

In addition, a safety valve 8 is provided on the primary piping 1 between the pump P and the water flow detection device 3. The safety valve 8 has a function of letting water in the primary piping 1 escape when the pressure in the primary piping 1 becomes excessively high to exceed a predetermined pressure value. The pressure at which the safety valve 8 is opened is set to a value that is more than the pressure at which the auxiliary pressurization pump 7 is actuated.

Some buildings such as large warehouses and factories have a folded plate roof structure. The advantages of a folded plate roof R (FIG. 1) are that folded plates formed from metal are lightweight and inexpensive and that the folded plate roof R can be built in a short period. However, the folded plate roof R tends to be affected by the outside temperature such as the heat of summer and the coldness of winter. Therefore, water inside the secondary piping 2 which is disposed near the folded plate roof R tends to be abnormally pressurized in summer and frozen in winter, which tends to damage the sprinkler head S. In some buildings, all or a part of the secondary piping 2 is installed at a location exposed to the outside air. Also in this case, as in the case described above, the sprinkler head S tends to be affected by the outside temperature. According to the present invention, breakage of the sprinkler head S due to abnormal pressurization or freezing of water in the secondary piping 2 which is disposed near the folded plate roof R can be prevented, and a fire can be extinguished immediately with the pump P started without delay at the time of a fire.

### Modification of First Embodiment

Next, a modification of the first embodiment will be described. In this modification, the pressure difference (first pressure difference) at the time when the relief valve 4 is opened is larger than the pressure difference (third pressure difference) between the pressure of water in the secondary piping 2 at normal times and the set pressure at which the pump start switch 5 is actuated. Components that are identical to those according to the first embodiment are given identical reference numerals to omit overlapping description.

In the FIRE EXTINGUISHING EQUIPMENT, the pressure in the secondary piping 2 is set to be higher than the pressure in the primary piping 1 at normal times (in the absence of a fire), and the pump P can be started before the relief valve 4 is opened at the time of a fire. For example, when the pressure in the secondary piping 2 is 1 MPa, the pressure in the primary piping 1 is lower at 0.9 MPa. The actuation pressure of the pump start switch 5 is 0.7 MPa.

When a fire occurs in a fire protection area of the water flow detection device 3a, the sprinkler head Sa which is connected to the secondary piping 2a of the water flow detection device 3a is actuated. Then, the nozzle S1 of the sprinkler head Sa is opened to sprinkle water charged in the secondary piping 2a in rooms. Consequently, the pressure in the secondary piping 2a is lowered.

When the secondary piping 2a is depressurized, the valve element 32 of the water flow detection device 3a is opened to supply water from the primary piping 1a to the secondary piping 2a. In addition, the water flow detection device 3a outputs an actuation signal along with operation to open the valve element 32. When the pressure in the primary piping 1 is gradually reduced to be lower than 0.7 MPa, the valve elements 41 of the relief valves 4b and 4c, which correspond to fire protection areas in which a fire is not caused, are opened. Before that, however, the pump start switch 5 is actuated to start the pump P when the pressure in the primary piping 1 reaches 0.7 MPa. Water in the water source W is continuously fed from the pump P, and a sufficient amount of water is sprinkled from the sprinkler head Sa, which has been actuated, to extinguish the fire.

In the case where the auxiliary pressurization pump 7 is provided on the primary piping 1 and the pressure of water in the secondary piping 2 is 1 MPa and the actuation pressure of the auxiliary pressurization pump 7 is in the range of 0.7 to 0.8 MPa, for example, the difference therebetween is 0.2 to 0.3 MPa. Meanwhile, the difference of the pressure on the secondary side with respect to the pressure on the primary side at the time when the relief valve 4 is opened is in the range of 0.3 to 0.4 MPa. When water leaks from the primary piping 1 and water in the primary piping 1 is gradually depressurized in the absence of a fire, the auxiliary pressurization pump 7 is started to supply water to the primary piping 1 before the pump start switch 5 is actuated, which prevents the relief valve 4 from being opened.

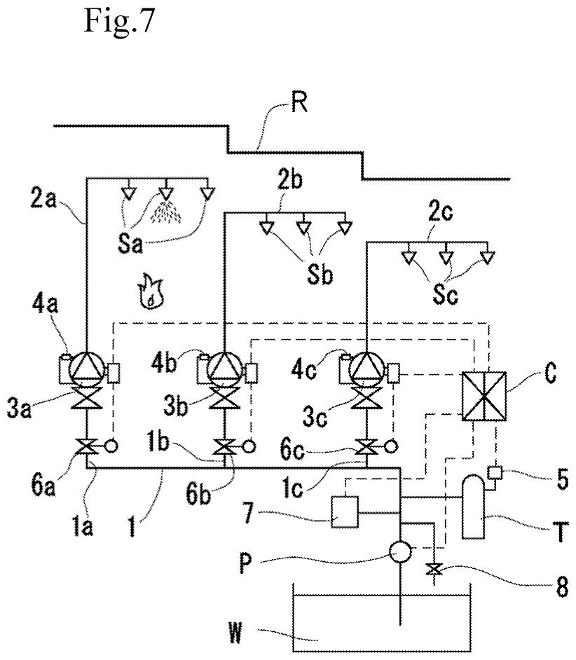

### Second Embodiment [FIG. 7]

A second embodiment of the present invention will be described. In the second embodiment, in addition to the components of the FIRE EXTINGUISHING EQUIPMENT according to the first embodiment, an electric valve 6 (6a, 6b, 6c) that enables passage of water at normal times is provided in the primary piping 1a, 1b, and 1c which are branched from each other for each fire protection area, and the electric valves 6 for fire protection areas in which a fire is not caused are closed when the water flow detection device 3 for a fire protection area in which a fire is caused is actuated. Consequently, the electric valves which are installed on the primary piping 1 in a non-fire system which excludes a fire protection area, for which an actuation signal is output, can be closed when a fire is caused so that the relief valves 4 for the fire protection areas in which a fire is not caused is not opened.

The configuration of the second embodiment will be described below. Components that are the same as those according to the first embodiment are described using the same reference numerals. The primary piping 1 illustrated in FIG. 7 is branched at the middle, and the branched pipes 1a, 1b, and 1c are provided with the water flow detection devices 3a, 3b, and 3c, respectively. In addition, the electric valves 6 (6a, 6b, 6c) which are normally open are provided between the branched primary piping 1a, 1b, and 1c and the water flow detection devices 3a, 3b, and 3c, respectively. The water flow detection devices 3 and the electric valves 6 are electrically connected to a control device C.

In the FIRE EXTINGUISHING EQUIPMENT according to the second embodiment, the pressure in the secondary piping 2 is set to be higher than the pressure in the primary piping 1 at normal times (in the absence of a fire). For example, when the pressure in the secondary piping 2 is 1 MPa, the pressure in the primary piping 1 is lower at 0.8 MPa. The actuation pressure of the pump start switch 5 is 0.6 MPa.

When a fire occurs in a fire protection area of the water flow detection device 3a, the sprinkler head Sa which is connected to the secondary piping 2a of the water flow detection device 3a is actuated. When the nozzle S1 of the sprinkler head Sa which has been actuated is opened to sprinkle water charged in the secondary piping 2a in rooms, the pressure in the secondary piping 2a is lowered.

When the secondary piping 2a is depressurized, the valve element 32 of the water flow detection device 3a is opened to supply water from the primary piping 1 to the secondary piping 2. In addition, the water flow detection device 3a outputs an actuation signal along with operation to open the valve element 32. Upon receiving the actuation signal, the control device C closes the electric valves 6b and 6c which are installed for fire protection areas in which a fire is not caused. Since the electric valves 6b and 6c are closed, the valve elements 41 of the relief valves 4b and 4c for the fire protection areas in which a fire is not caused are kept closed even if the pressure in the primary piping 1 becomes lower than 0.7 MPa.

When the pressure in the primary piping 1 reaches 0.6 MPa, the pump start switch 5 is actuated to start the pump P. Water in the water source W is continuously fed from the pump P, and a sufficient amount of water is sprinkled from the sprinkler head Sa, which has been actuated, to extinguish the fire.

The electric valve 6 discussed earlier can also be installed in a conduit of the “first bypass piping”. In that event, the electric valve 6 can be installed between the relief valve 4 and the hole 34a of the water flow detection device 3.

The electric valve 6 may be completely closed, or may be closed to a half-open state to allow passage of some water on the assumption that a fire occurs in a different fire protection area. The “half-open state” as used herein refers to a state between a closed state in which the internal flow path of the electric valve 6 is completely closed and an open state in which the internal flow path thereof is completely open. Thus, the “half-open state” corresponds to a concept including a slightly open state in which the electric valve 6 is slightly open to allow a flow of water etc. In the case where the electric valve 6 is in the half-open state, the relief valves 4 for the fire protection areas in which a fire is not caused are opened to supply water from the secondary piping 2 to the primary piping 1, but the amount of inflow into the primary piping 1 can be suppressed.

With the FIRE EXTINGUISHING EQUIPMENT according to the present embodiment, in the case where the water flow detection device 3 which is installed for a certain fire protection area outputs an actuation signal when the electric valve 6 corresponding to the fire protection area is in the closed state or the half-open state, the electric valve 6 for the fire protection area can be returned to the open state. More particularly, when a fire occurs in a fire protection area of the water flow detection device 3a in FIG. 7, the water flow detection device 3a sends an actuation signal to the control device C. The control device C brings the electric valves 6b and 6c for the other fire protection areas, in which a fire is not caused, to the closed state. Next, when the fire spreads to a different fire protection area and the sprinkler head S which is connected to the water flow detection device 3b is actuated, the water flow detection device 3b outputs an actuation signal. Upon receiving the actuation signal, the control device C outputs a signal for opening the electric valve 6b.

Alternatively, all the electric valves 6a to 6c may be returned to the open state after the pump P is started.

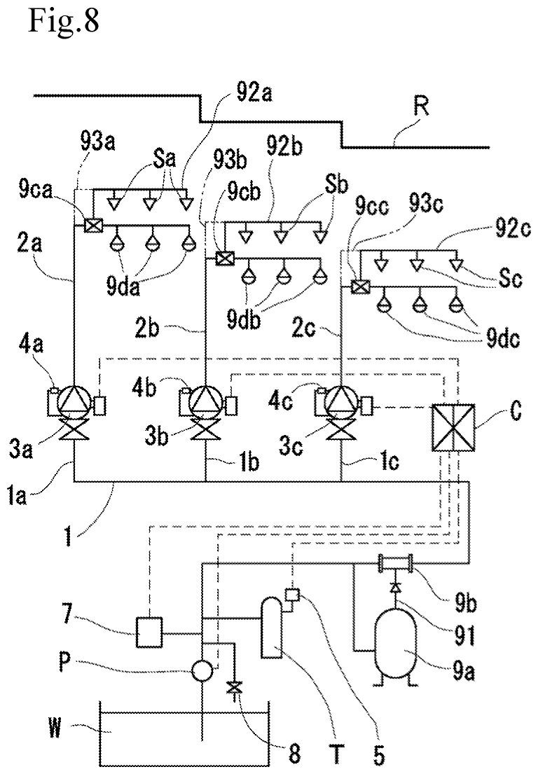

### Third Embodiment [FIG. 8]

In the embodiments described above, a sprinkler equipment is described as an example of the FIRE EXTINGUISHING EQUIPMENT. However, the FIRE EXTINGUISHING EQUIPMENT according to the present invention is also applicable to a foam FIRE EXTINGUISHING EQUIPMENT, fire extinguishing water for which contains chemicals. As illustrated in FIG. 8, the foam FIRE EXTINGUISHING EQUIPMENT is provided with a foam concentrate tank 9a, a mixer 9b, and deluge valves 9c (9ca, 9cb, 9cc), in addition to the components in FIG. 1.

The foam FIRE EXTINGUISHING EQUIPMENT includes, in addition to the components of the FIRE EXTINGUISHING EQUIPMENT according to the first embodiment, the foam concentrate tank 9a which accommodates a foam concentrate, the mixer 9b which connects between the water source W and the foam concentrate tank 9a and which delivers a foam aqueous solution obtained by mixing the foam concentrate and water at predetermined proportions to the water flow detection devices 3a, 3b, and 3c, the deluge valves 9c (9ca, 9cb, 9cc) of a lift valve structure which are installed in the secondary piping 2a, 2b, and 2c for the water flow detection devices 3a, 3b, and 3c, and foam heads 9d (9da, 9db, 9dc) installed on the secondary side of the deluge valve 9c. At normal times, the internal flow path of the deluge valve 9c is closed by the pressure of a fluid charged inside detection piping 92 (92a, 92b, 92c) connected to the deluge valve 9c. The sprinkler head S (Sa, Sb, Sc) is connected to the detection piping 92.

The foam concentrate tank 9a accommodates chemicals that serve as a foam concentrate inside. The foam concentrate tank 9a is connected to the mixer 9b by piping. The chemicals in the foam concentrate tank 9a are delivered to the mixer 9b when the pump P operates.

The mixer 9b has a tubular shape. The primary side of the mixer 9b is connected to piping connected to the pump P and the water source W, and the secondary side thereof is connected to the primary piping 1. Chemical supply piping 91 connected to the foam concentrate tank 9a is connected to the middle of the mixer 9b. Water from the water source W and the chemicals which are supplied from the foam concentrate tank 9a are mixed at predetermined proportions inside the mixer 9b to form a foam aqueous solution to be delivered to the primary piping 1.

The deluge valves 9c (9ca, 9cb, 9cc) have a lift valve structure inside. The primary side of the deluge valve 9c is connected to the water flow detection device 3, and the secondary side thereof is connected to the foam head 9d. A deluge valve structured as described in Japanese Unexamined Patent Application Publication No. 2006-345883, for example, can be used as the deluge valve 9c. At normal times, the internal passage of the deluge valve 9c is closed by the pressure of a fluid charged inside the detection piping 92 which is connected to the deluge valve 9c. The sprinkler head S is installed on the detection piping 92.

Next, operation of the foam FIRE EXTINGUISHING EQUIPMENT in FIG. 8 at the time of a fire will be described. Operation of the relief valve 4 is the same as that according to the first embodiment etc. described earlier, and therefore is not described.

When the sprinkler head Sa is actuated and a fluid inside the detection piping 92a is discharged from the sprinkler head Sa which has been actuated, for example, at the time of a fire, the pressure (detection piping pressure) of the fluid inside the detection piping 92a is lowered. Then, the deluge valve 9ca, which has been kept closed by the pressure of the fluid inside the detection piping 92a, is opened to supply a foam aqueous solution to the foam head 9da. The water flow detection device 3a is opened when the deluge valve 9ca is opened. As the water flow detection device 3a outputs an actuation signal, a foam aqueous solution is supplied from the primary piping 1 (1a) to the foam head 9da, which depressurizes the primary piping 1 as a whole.

When the primary piping 1 is depressurized and the pump P is started, the chemicals (foam concentrate) in the foam concentrate tank 9a are delivered to the mixer 9b to be mixed with water from the water source W, which is fed by the pump P, at predetermined proportions to form a foam aqueous solution, which is continuously fed to the water flow detection device 3a. The foam aqueous solution is supplied from the water flow detection device 3a to the foam head 9da by way of the deluge valve 9ca, foamed by the foam head 9da, and sprinkled in a fire protection area in which a fire is caused.

The foam FIRE EXTINGUISHING EQUIPMENT may be installed in a parking lot. Therefore, all or a part of the secondary piping 2 is occasionally installed outdoor. With the foam FIRE EXTINGUISHING EQUIPMENT according to the present embodiment, breakage of the sprinkler head S (detection head) and the deluge valve 9c due to abnormal pressurization or freezing in the secondary piping 2 can be prevented. At the time of a fire, further, the pump P can be started without delay to extinguish the fire immediately. Second bypass piping 93 (indicated by the double-dashed line; 93a, 93b, 93c) that connects between the detection piping 92, which is provided with the sprinkler head S which is connected to the deluge valve 9c, and piping on the primary side of the deluge valve 9c can be provided, and the relief valve 4 according to the first embodiment can be installed in a conduit of the second bypass piping 93.

### Modifications of Embodiments

The fire extinguishing facilities illustrated in FIGS. 1, 7, and 8 are provided with the control device C. The control device C is electrically connected to the water flow detection device 3, the pump start switch 5, the pump P, and the auxiliary pressurization pump 7. While the control device C is provided at only one location in FIGS. 1, 7, and 8, the control device C can be provided near each of the constituent devices such as the pump P and the auxiliary pressurization pump 7. That is, a plurality of control devices C may be provided. The control device C can be set such that the pump P is started upon receiving an actuation signal output from the water flow detection device 3.

The fire extinguishing facilities described above include the pump P which feeds water in the water source W to piping, the water flow detection device 3 which is connected to the pump P through piping, and the sprinkler head S which is connected to the secondary piping 2 on the secondary side of the water flow detection device 3. A plurality of water flow detection devices are installed for fire protection areas. The primary piping 1 is connected to the pump P. The pump P is started in accordance with an actuation signal from the water flow detection device 3. The relief valve 4, which is installed on bypass piping that connects between the primary side and the secondary side of the water flow detection device 3, is opened when the pressure difference of the secondary-side pressure with respect to the primary-side pressure is equal to or more than a predetermined set value. The cross-sectional area of the minimum flow passage diameter portion of the relief valve 4 is smaller than the cross-sectional area of the outlet S2 of the nozzle S1 of the sprinkler head S.

In an embodiment other than those described above, a pressure switch can be provided on the inflow side of the relief valve 4 to monitor the pressure in the secondary piping 2. The condition for the pressure switch to output a signal may be a value that is equal to or more than a pressure value at the time when the relief valve 4 is opened, for example. More specifically, a pressure switch that outputs a signal in response to a value that is equal to or more than a pressure value obtained by adding 0.15 to 0.4 MPa to the pressure in the secondary piping 2 at normal times can be provided on the inflow side of the relief valve 4.

In the embodiments described earlier, in the case where the pressure difference between the primary piping 1 and the secondary piping 2 at which the relief valve 4 is opened is in the range of 0.15 MPa to 0.4 MPa, the pressure in the secondary piping 2 at the time when the relief valve 4 is opened is 1.15 to 1.4 MPa when the pressure in the secondary piping 2 at normal times is 1 MPa. When the pressure difference between the primary piping 1 and the secondary piping 2 at which the relief valve 4 is opened is in the range of 0.3 MPa to 0.4 MPa, meanwhile, the pressure in the secondary piping 2 at the time when the relief valve 4 is opened is 1.3 to 1.4 MPa, which is more preferable.

Thus, the pressure switch is set so as to output a signal in the case where the pressure in the secondary piping 2 becomes equal to or more than this range. With this configuration, abnormal pressurization in the secondary piping 2 can be detected in accordance with a signal from the pressure switch in the case where the relief valve 4 is at fault. The condition for the pressure switch to output a signal may be a value that is more than the pressure in the secondary piping 2 at normal times and that is less than the pressure therein at the time when the relief valve 4 is opened.

In the case where the pressure switch outputs a detection signal for more than a predetermined time, the relief valve 4 can be at fault, and thus a secondary-side abnormal signal is output. This prompts a person who has received the secondary-side abnormal signal to drain water from the secondary piping 2 and return the pressure to the normal range.

What is claimed is:

1. A FIRE EXTINGUISHING EQUIPMENT comprising:
a pump that feeds water in a water source;
primary piping connected to the pump;
a water flow detection device connected to the primary piping;
secondary piping connected to the water flow detection device; and
a sprinkler head connected to the secondary piping,
wherein the primary piping includes a plurality of branched pipes that extend as branched in correspondence with a plurality of fire protection areas of a building, the water flow detection device being connected to each of the branched pipes,
the FIRE EXTINGUISHING EQUIPMENT further includes
first bypass piping that passes outside the water flow detection device to connect between the primary piping and the secondary piping, and
a relief valve provided in a conduit of the first bypass piping,
the relief valve is opened to supply water in the secondary piping to the primary piping when a difference of a secondary-side pressure in the secondary piping with respect to a primary-side pressure in the primary piping becomes more than a first pressure difference, and
a cross-sectional area of a minimum flow passage diameter portion of the relief valve is smaller than a cross-sectional area of a nozzle outlet of the sprinkler head.

2. The FIRE EXTINGUISHING EQUIPMENT according to claim 1,
wherein a ratio of the cross-sectional area of the nozzle outlet of the sprinkler head and the cross-sectional area of the minimum flow passage diameter portion of the relief valve is equal to or less than 1:0.3.

3. The FIRE EXTINGUISHING EQUIPMENT according to claim 1,
wherein the relief valve is opened when the first pressure difference is 0.15 to 0.4 MPa.

4. The FIRE EXTINGUISHING EQUIPMENT according to claim 1,
wherein the secondary-side pressure is set to be higher than the primary-side pressure at normal times.

5. The FIRE EXTINGUISHING EQUIPMENT according to claim 1,
wherein the primary piping is provided with a safety valve that discharges water in the primary piping to outside in a case where the primary-side pressure becomes more than a predetermined pressure value.

6. The FIRE EXTINGUISHING EQUIPMENT according to claim 1,
wherein the primary piping is provided with an auxiliary pressurization pump, and
a discharge amount of the auxiliary pressurization pump is larger than a water flow amount of the relief valve which is opened.

7. The FIRE EXTINGUISHING EQUIPMENT according to claim 6,
wherein the first pressure difference at a time when the relief valve is opened is larger than a second pressure difference which is a difference between the secondary-side pressure at normal times and the primary-side pressure at a time when the auxiliary pressurization pump is actuated.

8. The FIRE EXTINGUISHING EQUIPMENT according to claim 1, further comprising
a pump start switch installed on the primary piping,
wherein the first pressure difference at a time when the relief valve is opened is larger than a third pressure difference which is a difference between the secondary-side pressure at normal times and the primary-side pressure at a time when the pump start switch is actuated.

9. The FIRE EXTINGUISHING EQUIPMENT according to claim 1, further comprising
an electric valve that is provided in a conduit of each of the branched pipes and that is in an open state at normal times to enable passage of water,
wherein, when the water flow detection device for the fire protection area in which a fire is caused is actuated, the electric valve for the fire protection area in which the fire is caused is maintained in the open state to enable passage of water, and the electric valve for the fire protection area in which the fire is not caused is closed to limit passage of water.

10. The FIRE EXTINGUISHING EQUIPMENT according to claim 9,
wherein the electric valve is closed to a half-open state between the open state in which a valve element of the electric valve is fully open and a closed state in which the valve element thereof is fully closed.

11. The FIRE EXTINGUISHING EQUIPMENT according to claim 10,
wherein, when a fire occurs in the fire protection area, in which the fire has not been caused and the electric valve for which has been in the closed state or the half-open state, the electric valve which has been in the closed state or the half-open state is opened in accordance with an actuation signal output from the water flow detection device corresponding to the fire protection area.

12. The FIRE EXTINGUISHING EQUIPMENT according to claim 1, further comprising
a foam concentrate tank that accommodates a foam concentrate,
a mixer connected to the water source and the foam concentrate tank, the mixer mixing the foam concentrate and water in the water source to form a foam aqueous solution to be fed to the water flow detection device,
a deluge valve of a lift valve structure installed in the secondary piping for the water flow detection device, and
a foam head installed on a secondary side of the deluge valve,
wherein a flow passage inside the deluge valve is closed by a pressure of a fluid charged in a conduit of detection piping connected the secondary side of the deluge valve at normal times, and
the sprinkler head is connected to the detection piping.

13. The FIRE EXTINGUISHING EQUIPMENT according to claim 12,
wherein second bypass piping is provided to connect between a primary side of the deluge valve and the detection piping, and
the relief valve is also installed in a conduit of the second bypass piping.

14. The FIRE EXTINGUISHING EQUIPMENT according to claim 1, further comprising
a pressure switch provided on a primary side of the relief valve to output a signal in response to a pressure that is more than a pressure obtained by adding 0.15 to 0.4 MPa to the secondary-side pressure at normal times.
